(19) United States
(12) Patent Application Publication
(10) Pub. No.: US 2009/0145871 A1
(43) Pub. Date: Jun. 11, 2009

(54) Wireless and wired control mechanism for an aerial lift or crane

(76) Inventor: Anthony E. Bond, Omaha, NE (US)

Correspondence Address: THOMTE LAW OFFICE, L.L.C., 2120 S. 72ND STREET, SUITE 1111, OMAHA, NE, 68124, US

(21) Appl. No.: 11/999,771

(22) Filed: Dec. 7, 2007

(51) Int. Cl. B66C 13/44

(52) U.S. Cl. 212/285

(57) ABSTRACT

A wireless and wired control mechanism is provided for an aerial lift or crane wherein a control box is located within the work platform of the aerial lift. The control box is hard wired to a radio receiver in the control mechanism of the aerial lift or crane. The control box is also wireless connected to the control mechanism which permits a radio transmitter in the control box to transmit signals to the control mechanism when the hard wired connection between the control box and the control mechanism is disconnected. The control box is conveniently movable within the work platform and may be completely removed therefrom so that an operator may control the functions of the aerial lift or crane from the ground by way of the wireless connection.

### CROSS-REFERENCE TO RELATED APPLICATION

This application claims the benefit of U.S. Provisional Application Ser. No. 60/898,954 entitled “WIRELESS AND WIRED CONTROL MECHANISM FOR AN AERIAL LIFT OR CRANE” filed Feb. 1, 2007, the disclosure of which is hereby incorporated herein by reference.

### BACKGROUND OF THE INVENTION

1. Field of the Invention

This invention relates to a wireless and a hard wired control mechanism for an aerial lift or crane and more particularly to a control box which is located on the aerial work platform mounted on the outer end of the telescoping boom of the aerial lift or crane with the control box being hard wired to the control means for the aerial lift or crane and having wireless connection to the control means by means of a wireless transmitter/receiver connection.

2. Description of the Related Art

Aerial lifts typically comprise a telescoping boom mounted on a vehicle such as a truck or the like with a work platform being mounted on the outer end of the boom. In some cases, the aerial boom also has a sheave or pulley mounted at the outer end thereof to enable a hoisting line or cable to be extended thereover so that the aerial lift may be used as a crane. Typically, a wireless control box is mounted on the work platform and includes levers, joysticks, etc., to operate boom functions. Radio signals are transmitted from the operator on the work platform to the control means located on the vehicle and function generally satisfactorily, but, in some cases, the radio signals suffer from interference. Further, in some types of prior art aerial lifts or cranes, a hard wired control box is located on the vehicle and has a lead or connector tethered thereto which hard wires the control box to the control means. Typically, the connector or tether is 20 to 30 feet long and thereby limits the ability to control the crane or lift functions due to the length of the connector or tether at ground level.

### SUMMARY OF THE INVENTION

An aerial lift or crane is described which is mounted on a vehicle with the aerial lift or crane including a telescoping boom having an aerial work platform mounted on the outer end thereof. A control means is mounted on the vehicle and includes a radio receiver which is remote from the aerial work platform to enable an operator to remotely control the various functions of the boom and other components of the aerial lift or crane from the work platform. A control box is mounted on the work platform which is hard wired and wireless connected to the radio receiver whereby the operator in the work platform may operate the control means via the hard wired connection between the control box and the control means or by means of the wireless connection. The control box is mounted on the work platform in a manner whereby an operator may transmit control signals to the radio receiver to control the various functions of the boom and other components of the aerial lift or crane by means of the hard wired connection. If the hard wired connection is disconnected the wireless connection may be utilized. The control box is selectively removably mounted on the work platform whereby an operator may conveniently move the control box within the work platform to a more convenient location within the work platform or may remove the control box from the work platform to operate the aerial lift or crane from the ground.

It is therefore a principal object of the invention to provide a wireless and hard wired control mechanism for an aerial lift or crane.

A further object of the invention is to provide a wireless/hard wired control mechanism for an aerial lift or crane whereby the control box thereof may be moved within the work platform of the aerial lift or may be completely removed from the work platform so as to control the boom and crane functions from the ground by way of the wireless connection.

A further object of the invention is to provide a wireless/hard wired control mechanism for an aerial lift or crane which enables the operator within the work basket to have more freedom of movement to control the functions of the boom or crane.

Yet another object of the invention is to provide a wireless and wired control mechanism for an aerial lift or crane which does not create a battery drain on the wireless control mechanism during periods of boom or crane operation by way of the hard wired control mechanism.

These and other objects will be apparent to those skilled in the art.

### BRIEF DESCRIPTION OF THE DRAWINGS

FIG. 1 is a perspective view of an aerial lift of this invention; and

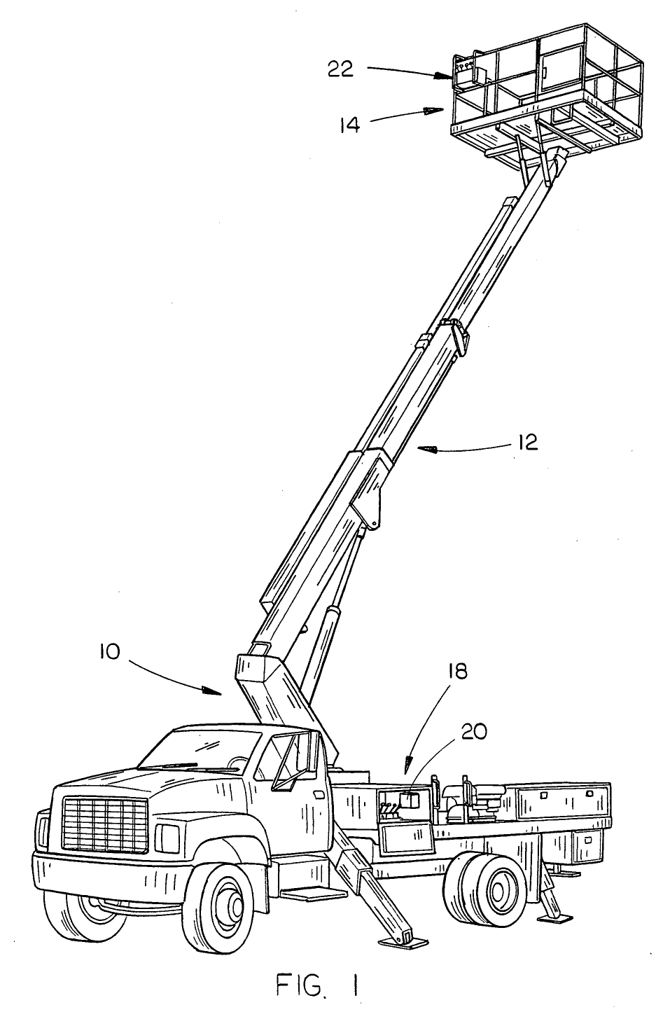

FIG. 2 is a partial perspective view illustrating the manner in which the boom functions are controllable.

### DETAILED DESCRIPTION OF THE INVENTION

The numeral 10 refers generally to a truck-mounted aerial lift including a telescoping boom 12 having a work platform 14 mounted on the outer end of the boom 12 which may or may not be removable therefrom. In many cases, the outer end of the telescoping boom 12 will have a pulley or sheave over which a lifting or hoisting cable may be extended so that the aerial lift may function as a crane. The aerial lift 10 includes a control means 18 which is normally located behind the cab of the aerial lift or at one side of the aerial lift. The control means 18 includes a radio receiver 20 which normally interprets the transmitter frequencies, and delivers voltage output to a hydraulic valve after the hydraulic valve receives the voltage output from the receiver 20, then an appropriate boom function will occur.

A control box 22 is selectively removably mounted to one side of the work platform 14 and includes the normal levers, joysticks, etc. The control box 22 is hard wired to the receiver 20 by wires or lines 23 so that the operator may control the functions of the boom or crane through the receiver 20 of the control means 18. Preferably, an on/off switch 24 is provided in the hard wired connection to enable the hard wired connection between the control box 22 and radio receiver 20 to be disconnected.

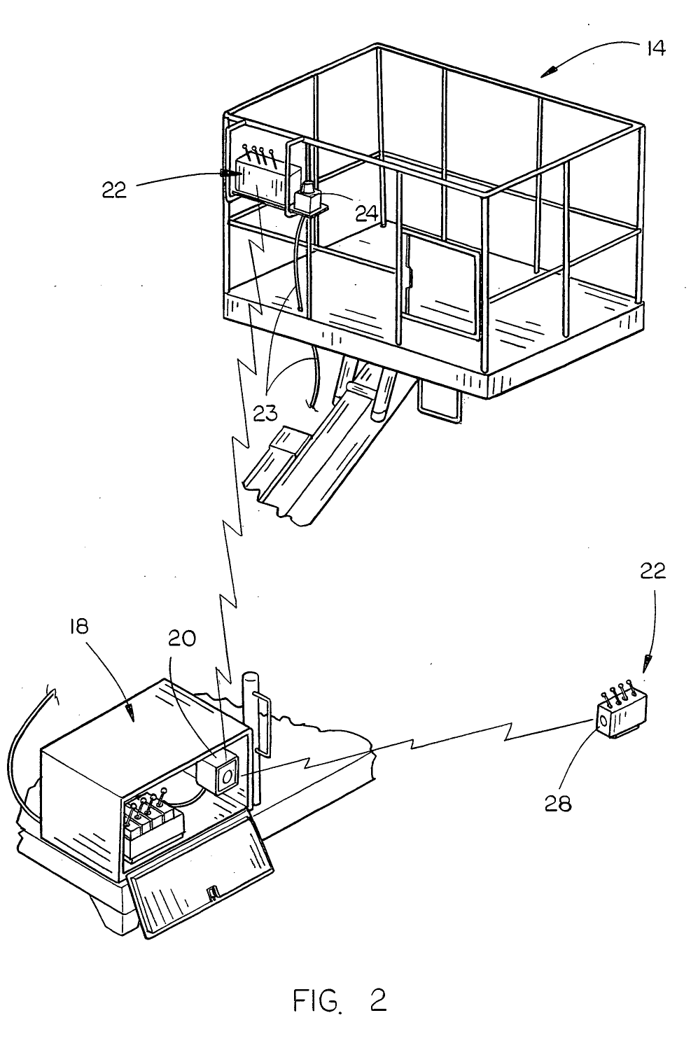

Many times, the control box 22 is not in a convenient location within the platform 14 to enable the operator to conveniently operate the same. For example, if the control box 22 is located at one side of the work platform 14 and the operator must observe or work from the other side of the work platform 14, it is difficult for the operator to reach the control box 22. It is for that reason that the control box is removably mounted within the work platform 14. The control box 22 includes a radio transmitter 28 which is capable of transmitting signals to the receiver 20 when the hard wired connection between control box 22 and radio receiver 20 is disconnected so that the operator may control the various functions of the boom 12 and the aerial lift as required. Inasmuch as the control box 22 is removably mounted on the work platform 14, the control box 22 may be moved to any location within the work platform 14 as desired so that the operator may conveniently operate the same. Further, the fact that the control box 22 is removably mounted on the work platform 14 enables the control box 26 to be completely removed from the work platform 14 so that an operator may control the operation of the functions of the boom and other components from a location on the ground, as seen in FIG. 2. Preferably, the control box 22 includes a battery pack. When the control box 22 is hard wired, the control box 22 will conserve battery life.

Thus it can be seen that the invention accomplishes at least all of its stated objectives.

I claim:

1. In combination:
an aerial lift or crane mounted on a vehicle;
said aerial lift or crane including a telescoping boom having an aerial work platform mounted on the outer end thereof;
control means including a radio receiver on said vehicle remote from said aerial work platform which controls the various functions of said boom and other components of said aerial lift or crane;
a control box on said work platform which is hard wired to said radio receiver whereby an operator in said work platform may operate said control means via the hard wired connection between said control box and said radio receiver;
said control box including a radio transmitter capable of transmitting signals to said radio receiver when the hard wired connection between said control box and said radio receiver is disconnected so that an operator may control the various functions of said aerial lift or crane and said boom; and
said control box being selectively removably mounted on said work platform whereby an operator may move said control box within said work platform or may remove said control box from said work platform to operate said aerial lift or crane from the ground.

2. The combination of claim 1 wherein said radio transmitter is battery operated.

3. The combination of claim 1 wherein said control box includes a battery pack for powering said radio transmitter.

4. The combination of claim 1 wherein an on/off switch is provided in the hard wired connection between said control box and said radio receiver to enable the hard wired connection therebetween to be disconnected.
